(19) United States
(12) Patent Application Publication
(10) Pub. No.: US 2025/0181944 A1
(43) Pub. Date: Jun. 5, 2025

(54) METHOD AND DEVICES OF AN EFFICIENT MULTI-DIMENSIONAL GAUSSIAN MIXTURE MODEL (GMM) REPRESENTATION OF A DATA SET IN A COMPUTING ENVIRONMENT

(71) Applicants: Mateusz Przyborowski, Elk (PL); Mateusz Wnuk, Legionowo (PL); Jaroslaw Litwin, Warsaw (PL); Maciej Bartoszuk, Warsaw (PL); Andrzej Janusz, Warsaw (PL); Dominik Slezak, Warsaw (PL)

(72) Inventors: Mateusz Przyborowski, Elk (PL); Mateusz Wnuk, Legionowo (PL); Jaroslaw Litwin, Warsaw (PL); Maciej Bartoszuk, Warsaw (PL); Andrzej Janusz, Warsaw (PL); Dominik Slezak, Warsaw (PL)

(21) Appl. No.: 18/524,585

(22) Filed: Nov. 30, 2023

(51) Int. Cl. G06N 7/00

(52) U.S. Cl. CPC G06N 7/00

(57) ABSTRACT

Disclosed are a method and devices of an efficient Gaussian Mixture Model (GMM) representation of a data set in a computing environment. In accordance therewith, a GMM distribution is constructed separately for each column of the data set to form a number of GMM distributions. The data set is enriched by adding a new data column whose numeric values correspond to one or more specific row(s) of the data set. The multi-dimensional GMM representation is then formed as including a discrete probability distribution of the numeric values of the new data column, sets of parameters of all of the number of GMM distributions, and correlation coefficients between the numeric values of the new data column and constituent Gaussian distributions of the number of GMM distributions.

### FIELD OF TECHNOLOGY

This disclosure relates generally to big data processing and, more particularly, to a method and/or devices of an efficient multi-dimensional Gaussian Mixture Model (GMM) representation of a data set in a computing environment.

### BACKGROUND

A computing environment may involve processing large data sets including large volumes of and/or complex data. The computing environment may, for example, be a Machine Learning (ML) environment involving large training data sets. An example data set may be in a tabular form with rows (e.g., a multi-dimensional data set) and columns. While a probabilistic model such as a Gaussian Mixture Model (GMM) may represent each column of the multi-dimensional data set, representation of the multi-dimensional data set using GMMs may be complex, computation-intensive and/or memory-inefficient. Further, the aforementioned representation may not accurately capture correlations, patterns and/or dependencies between numeric values across the different columns of the multi-dimensional data set.

### SUMMARY

Disclosed are a method and/or devices of an efficient multi-dimensional Gaussian Mixture Model (GMM) representation of a data set in a computing environment.

In one aspect, a method of generating a multi-dimensional Gaussian Mixture Model (GMM) representation of a data set using a processor communicatively coupled to a memory is disclosed. The method includes constructing a GMM distribution separately for each column of the data set to form a number of GMM distributions, and enriching the data set by adding a new data column whose numeric values correspond to one or more specific row(s) of the data set. The numeric values of the new data column are chosen in accordance with maximizing an average correlation between the new data column and one or more GMM distribution(s) of the number of GMM distributions corresponding to one or more specific column(s) of the data set.

The method also includes forming the multi-dimensional GMM representation as including a discrete probability distribution of the numeric values of the new data column, sets of parameters of all of the number of GMM distributions, and correlation coefficients between the numeric values of the new data column and constituent Gaussian distributions of the number of GMM distributions. Further, the method includes encoding, through the numeric values of the new data column, correlations between the numeric values across the columns of the data set in order to calculate the correlation coefficients directly from the new data column and the number of GMM distributions, and reducing a data footprint of the data set in accordance with the forming of the multi-dimensional GMM representation.

In another aspect, a data processing device to generate a multi-dimensional GMM representation of a data set includes a memory, and a processor communicatively coupled to the memory. The processor executes instructions stored in the memory to construct a GMM distribution separately for each column of the data set to form a number of GMM distributions, and enrich the data set by adding a new data column whose numeric values correspond to one or more specific row(s) of the data set. The numeric values of the new data column are chosen in accordance with maximizing an average correlation between the new data column and one or more GMM distribution(s) of the number of GMM distributions corresponding to one or more specific column(s) of the data set.

The processor also executes instructions to form the multi-dimensional GMM representation as including a discrete probability distribution of the numeric values of the new data column, sets of parameters of all of the number of GMM distributions, and correlation coefficients between the numeric values of the new data column and constituent Gaussian distributions of the number of GMM distributions. Further, the processor executes instructions to encode, through the numeric values of the new data column, correlations between the numeric values across the columns of the data set in order to calculate the correlation coefficients directly from the new data column and the number of GMM distributions, and to reduce a data footprint of the data set in accordance with the forming of the multi-dimensional GMM representation.

In yet another aspect, a data processing device to generate a multi-dimensional GMM representation of a data set includes a memory, and a processor communicatively coupled to the memory. The processor executes instructions stored in the memory to construct a GMM distribution separately for each column of the data set to form a number of GMM distributions, and enrich the data set by adding a new data column whose numeric values correspond to one or more specific row(s) of the data set. The numeric values of the new data column are chosen in accordance with maximizing an average correlation between the new data column and one or more GMM distribution(s) of the number of GMM distributions corresponding to one or more specific column(s) of the data set.

The processor also executes instructions to form the multi-dimensional GMM representation as including a discrete probability distribution of the numeric values of the new data column, sets of parameters of all of the number of GMM distributions, and correlation coefficients between the numeric values of the new data column and constituent Gaussian distributions of the number of GMM distributions. Further, the processor executes instructions to encode, through the numeric values of the new data column, correlations between the numeric values across the columns of the data set in order to calculate the correlation coefficients directly from the new data column and the number of GMM distributions, and to utilize the multi-dimensional GMM representation along with or instead of the data set for computation using a Machine Learning (ML) algorithm also executing on the processor.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a computing system, according to one or more embodiments.

FIG. 2 a schematic view of elements of the computing system of FIG. 1 involved in computation of a multi-dimensional GMM representation of input data thereto, according to one or more embodiments.

FIG. 3 is a more detailed schematic view of the elements of the computing system of FIGS. 1-2 involved in the computation of the multi-dimensional GMM representation of the input data thereto, according to one or more embodiments.

Other features of the present embodiments will be apparent from the accompanying drawings and from the detailed description that follows.

### DETAILED DESCRIPTION

Example embodiments, as described below, may be used to provide a method and/or devices of an efficient multi-dimensional Gaussian Mixture Model (GMM) representation of a data set in a computing environment. Although the present embodiments have been described with reference to specific example embodiments, it will be evident that various modifications and changes may be made to these embodiments without departing from the broader spirit and scope of the various embodiments.

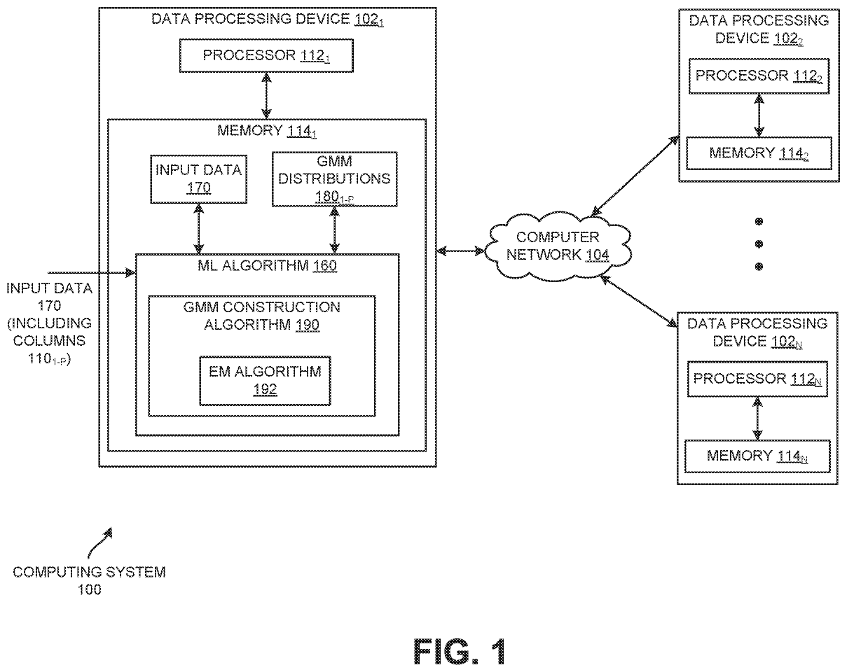

FIG. 1 shows a computing system 100, according to one or more embodiments. In one or more embodiments, computing system 100 may include a number of data processing devices 102_{1-N} communicatively coupled to one another through a computer network 104 (e.g., a Local Area Network (LAN), a Wide Area Network (WAN), the Internet, a short-range network based on Bluetooth®, WiFi® and the like). It should be noted that while exemplary embodiments have been placed within the context of computing system 100, concepts discussed herein may be applicable to a standalone data processing device 102_{1-N} of computing system 100. In one or more embodiments, data processing devices 102_{1-N} may include one or more server(s), one or more client device(s) and/or one or more portable computing devices (e.g., mobile phones, smart devices). In one or more embodiments, data processing devices 102_{1-N} of computing system 100 may constitute a distributed (e.g., across a cloud) network of data processing devices, a cluster of data processing devices and/or a hybrid network of data processing devices. All reasonable variations are within the scope of the exemplary embodiments discussed herein.

As shown in FIG. 1, in one or more embodiments, each data processing device 102_{1-N} may include a processor 112_{1-N} (e.g., a standalone processor, a network/cluster of processors) communicatively coupled to a memory 114_{1-N} (e.g., a volatile and/or a non-volatile memory). For example, data processing device 102₁ may implement a Machine Learning (ML) algorithm 160 therein. It should be noted that ML algorithm 160 may be implemented across more than one data processing device 102_{1-N} of computing system 100. However, ML algorithm 160 has been shown as executing solely on data processing device 102₁ (e.g., stored in memory 114₁ and executing on processor 112₁) merely for the sake of example. In one or more embodiments, ML algorithm 160 itself may include a set of algorithms.

FIG. 1 shows input data 170 to ML algorithm 160 (or, GMM construction algorithm 190 to be discussed below), according to one or more embodiments. In one or more embodiments, input data 170 may include data sets that are too large in volume and/or too complex to be handled conventionally. In one or more embodiments, in addition to storage and/or management requirements of input data 170 within computing system 100, useful information and/or insights may also need to be derived from input data 170 depending on the context (e.g., near real-time responses required in some, non-real-time responses in others). In one or more embodiments, input data 170 may take the form of multi-dimensional data having multiple sets of numeric values therein. For example, multi-dimensional data may be in a tabular form, i.e., in the form of a data table with a number of data columns. In the exemplary embodiments discussed herein, each data column of the number of data columns may have an independent single-dimensional Gaussian Mixed Model (GMM) employed as a representation thereof. In one or more embodiments, the corresponding independent single-dimensional GMM may summarize data elements (e.g., numeric values) of the each data column. In one or more embodiments, these independent one-dimensional GMMs may be transformed into a multidimensional representation that also takes into account correlations between occurrences of the numeric values of different data columns in input data 170.

If in an example data set (e.g., input data 170) there are 10 columns in tabular form, 10 independent GMMs may be generated such that each independent GMM may approximate a corresponding one-dimensional distribution in a column. However, these one-dimensional representations may not express correlations, patterns and/or dependencies that may be observed between numeric values across the different columns in input data 170. If we assume identical columns in input data 170 as an edge case, identical one-dimensional GMMs may be generated for these identical columns. However, they may not reveal a one-to-one correspondence between occurrences of numeric values thereacross. Exemplary embodiments discussed herein may relate to creation and use of multi-dimensional GMM representations that take the aforementioned correlations into account.

In one or more embodiments, in general, GMMs may be employed in many computational areas including but not limited to data analysis and processing, ranging from image segmentation and sound recognition to multidimensional clustering and data visualization. Exemplary embodiments discussed herein may be additionally applicable to utilization of GMMs to describe the contents of big data sets such as input data 170 and accelerating analytical and Artificial Intelligence (AI)/ML-related computations (e.g., computations implemented through ML algorithm 160) over said big data sets.

In some embodiments, more than one Gaussian distribution may describe the contents of each data column of input data 170 (or, an input data set). Thus, in one or more embodiments, the GMM incorporating these Gaussian distributions may be treated as summaries of the each data column of input data 170. In one or more embodiments, the distributions (e.g., GMM distributions 180_{1-P}) associated with the derived one-dimensional GMMs for all data columns (e.g., columns 110_{1-P}) of input data 170 may be stored along with input data 170 in memory 114₁ as shown in FIG. 1. In one or more embodiments, the aforementioned GMM distributions 180_{1-P} may be computed through one or more available methods and/or new/proprietary methods.

For example, if a column 110_{1-P} of input data 170 included 1000 values and is described using 10 Gaussian components, each of which is described by 3 parameters (mean, standard deviation and weight/amplitude), it may be possible to operate with 30 parameters instead of the 1000 original values. In one or more embodiments, GMM distributions 180_{1-P} may be generated through a GMM construction algorithm 190 implemented as part of ML algorithm 160. In some embodiments, GMM construction algorithm 190 may be external to ML algorithm 160.

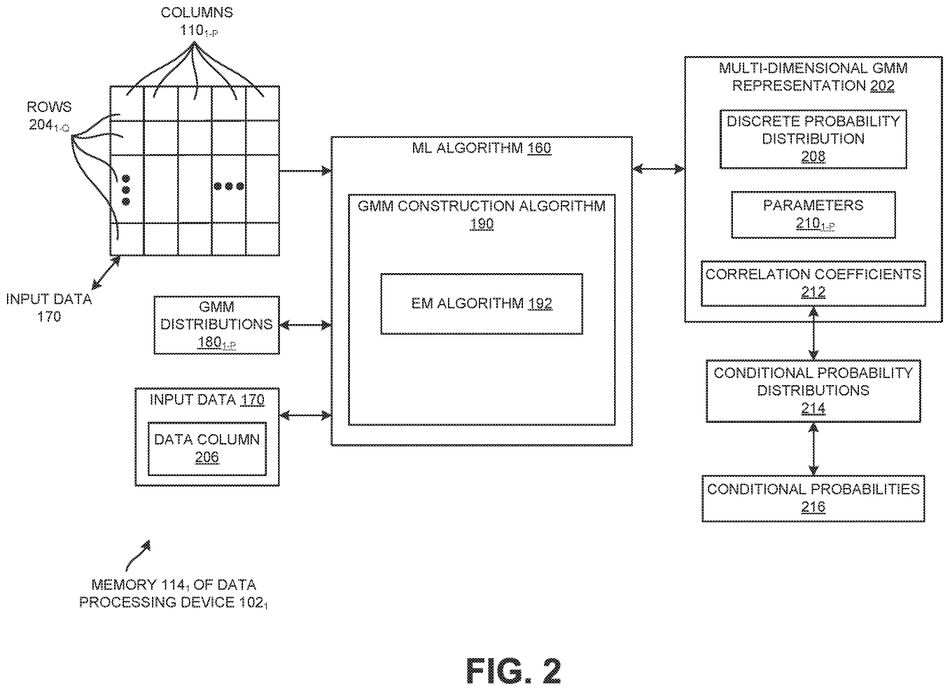

FIG. 2 shows computation of a multi-dimensional GMM representation 202 of input data 170 in a tabular form with numeric (e.g., integer, float, decimal) data columns (e.g., columns 110_{1-P}, i.e., P columns) using GMM construction algorithm 190, according to one or more embodiments. In one or more embodiments, input data 170 may include columns 110_{1-P} and rows 204_{1-Q} as shown in FIG. 2. In one or more embodiments, as discussed above, a one-dimensional GMM distribution 180_{1-P} may first be constructed for each column 110_{1-P} using one or more available and/or new/proprietary methods.

In one or more embodiments, following the construction of one-dimensional GMM distributions 180_{1-P} for all columns 110_{1-P}, input data 170 may be enriched by adding a new data column 206 in which numeric values corresponding to specific rows 204_{1-Q} in input data 170 may be chosen in order to maximize an average correlation between data column 206 and GMM distributions 180_{1-P} of specific/corresponding columns 110_{1-P}. Expressed in symbolic form,

avg Cₘ(DC,GMMⱼ)→yᵢ,

where yᵢ may denote the numeric value of data column 206 corresponding to specific i^{th} row/rows 204_{1-Q} in input data 170 chosen to maximize avg Cₘ (DC, GMMⱼ), which may be the average correlation between data column 206 DC and GMM distribution/distributions 180_{1-P} of the corresponding j^{th} column/columns 110_{1-P}.

Subsequently, in one or more embodiments, multi-dimensional GMM representation 202 may be formed as including a discrete probability distribution 208 of the numeric values of data column 206, the sets of parameters 210_{1-P} (e.g., mean, standard deviation, weight/amplitude for each constituent Gaussian distribution of a GMM distribution 180_{1-P} of a column 110_{1-P}) of all one-dimensional GMM distributions 180_{1-P}, and correlation coefficients 212 between said numeric values of data column 206 and constituent Gaussian distributions of the one-dimensional GMM distributions 180_{1-P}. In other words, in one or more embodiments, the numeric values yᵢ of data column 206 may encode the correlations between numeric values across columns 110_{1-P} in order to enable calculation of correlation coefficients 212 directly. In one or more embodiments, correlation coefficients 212 may be calculated directly from data column 206 and GMM distributions 180_{1-P}.

In one or more embodiments, correlation coefficients 212 may be expressed in the form of conditional probability distributions 214. In one or more embodiments, conditional probabilities 216 associated with conditional probability distributions 214 may be calculated in accordance with calculating, for each i^{th} row 2041Q and the j^{th} column 110_{1-P} of input data 170, the probabilities that the numeric value corresponding thereto may be generated (e.g., randomly) based on each constituent Gaussian distribution of GMM distribution 180_{1-P} of the j^{th} column 110_{1-P}. In one or more embodiments, conditional probabilities may be expressed as p (xᵢⱼ|GMMⱼ), where xᵢⱼ denotes the numeric value corresponding to the i^{th} row 204_{1-Q} and the j^{th} column 110_{1-P} of input data 170.

In one or more embodiments, for each numeric value of the added data column 206 yᵢ and each column 110_{1-P} j, p (xᵢⱼ|GMMⱼ) (e.g., conditional probability distributions 214) may be summed over all rows 204_{1-Q} that have the numeric value thereof in data column 206. In one or more embodiments, the summed p (xᵢⱼ|GMMⱼ) may then be normalized to the number of rows 204_{1-Q} that have the numeric value thereof in the added data column 206; this normalization may be done by dividing the summed p (xᵢⱼ|GMMⱼ) by the number of rows 204_{1-Q} that have the numeric value thereof in the added data column 206. In one or more embodiments, population of data column 206 may thus occur for all rows 204_{1-Q} in input data 170.

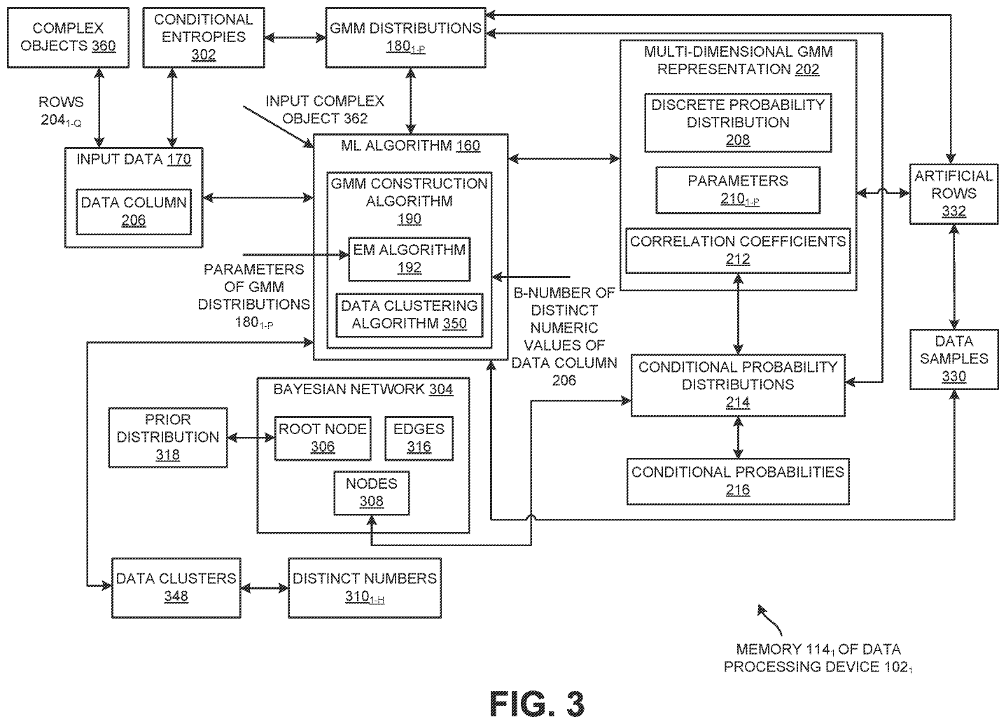

FIG. 3 shows elements of FIGS. 1-2 stored in memory 114₁, according to one or more embodiments. In one or more embodiments, the abovementioned processes (e.g., the population of data column 206 discussed above) may be optimized based on minimizing a sum of conditional entropies (e.g., conditional entropies 302) of GMM distributions 180_{1-P} of all columns 110_{1-P} subject to the added data column 206. Additionally or alternatively, in one or more embodiments, the population of data column 206 may also be optimized by maximizing an accuracy of a probabilistic Bayesian belief network (e.g., Bayesian network 304) having a root node (e.g., root node 306) corresponding to the added data column 206 and directed edges (e.g., edges 316) from the root node to each other node (e.g., part of nodes 308) corresponding to specific columns 110_{1-P}. In one or more embodiments, root node 306 may be associated with a prior distribution 318 of numeric values over data column 206 and nodes 308 may be associated with conditional probability distributions 214 of specific constituent Gaussian distributions of GMM distributions 180_{1-P} subject to specific numeric values yⱼ in added data column 206.

Conditional entropies and Bayesian belief networks are known to one skilled in the art. Detailed discussion associated therewith has been skipped for the sake of brevity and clarity. In one or more embodiments, the population of data column 206, i.e., choosing the numeric values to be added to data column 206 for all rows 204_{1-Q} in input data 170 may be accomplished by mapping every row 204_{1-Q} of input data 170 into a multi-dimensional space (e.g., multi-dimensional GMM representation 202) that is created by concatenating conditional probabilities 216, i.e., the probabilities that the numeric value of each row 204_{1-Q} on a specific column 110_{1-P} may be generated (e.g., randomly) using each constituent Gaussian distribution of GMM distribution 180_{1-P} of the specific column 110_{1-P}. In one or more example implementations, multi-dimensional GMM representation 202 of input data 170 may include a set of triples that is constituted by vectors of means, covariance matrices and weights. Here, a dimensionality of the multi-dimensional space may be equal to the number of concatenated probabilities.

In one or more embodiments, data clustering (e.g., using k-means clustering, agglomerative clustering) may then be performed for rows 204_{1-Q} in multi-dimensional GMM representation 202. In one or more embodiments, distinct numbers 310_{1-H} (e.g., H being the number of data clusters 348) may be assigned to data clusters 348 formed through the data clustering process. In one or more embodiments, each numeric value on data column 206 may be assigned one or more distinct numbers 310_{1-H} of data clusters 348 associated (e.g., the each numeric value may belong to a number of data clusters 348) therewith. The aforementioned data clustering may clearly be seen in FIG. 3.

In one or more embodiments, correlation between the one-dimensional GMM distributions 180_{1-P} may be calculated for every pair of columns 110_{1-P} in input data 170 by way of coefficients. In one or more embodiments, column 110_{1-P} whose GMM distribution 180_{1-P} is, on average, most strongly correlated to all other GMM distributions 180_{1-P} may then be selected. In one or more embodiments, data column 206 may then be derived from the selected column 110_{1-P} based on a discretization process (e.g., involving equal length discretization and/or equal support discretization).

In one or more embodiments, the number of distinct numeric values (B) of data column 206 may itself be specified as an input parameter to GMM construction algorithm 190. In one or more embodiments, in case the B distinct numeric values input to GMM construction algorithm 190 does not yield multi-dimensional GMM representation 202 that is a significantly better representative of an original joint data distribution (or, correlations, patterns and/or dependencies) across columns 110_{1-P} than a number of distinct numeric values lower than B specified as the input parameter, GMM construction algorithm 190 may update multi-dimensional GMM representation 202 with the construction thereof with the number of distinct numeric values lower than B.

In one or more embodiments, as discussed above, multi-dimensional GMM representation 202 may replace input data 170 in computing system 100/data processing device 102₁ and may be available as an approximate model of input data 170 for the purpose of any operations (e.g., based on executing ML algorithm 160) performed therein. In one or more other embodiments, multi-dimensional GMM representation 202 may be stored (e.g., as metadata) in memory 114₁ in addition to input data 170 and may be made available therethrough for the purpose of the aforementioned operations. In one or more embodiments, GMM distributions 180_{1-P} may also be stored as the metadata (or another metadata) of columns 110_{1-P} in memory 114₁ together with the abovementioned correlation-related information thereof with data column 206. In one or more embodiments, data column 206 may be stored/made available in memory 114₁ for the aforementioned operations, where distribution of numeric values in data column 206 may serve as yet another metadata of specific columns 110_{1-P}.

In one or more embodiments, the abovementioned operations performed through computing system 100/data processing device 102₁ may entail estimating a joint probability of a combination of constituent Gaussian distributions of GMM distribution 180_{1-P} for a subset of columns 110_{1-P}. Here, in one or more embodiments, the estimation may take the form of a summation over one or more numeric values of data column 206 that are equal to a prior probability of the aforementioned one or more numeric values on data column 206 multiplied by conditional probabilities 216 of specific constituent Gaussian distributions of GMM distribution 180_{1-P} subject to the aforementioned one or more numeric values.

In one or more embodiments, input data 170 may also be split into smaller subsets of rows 204_{1-Q}, where multi-dimensional GMM representations analogous to multi-dimensional GMM representation 202 may be constructed and stored in memory 114₁ for each smaller subset of rows 204_{1-Q} separately. In one or more embodiments, whenever an operation executing through data processing device 102₁/computing system 100 requires reference to multi-dimensional GMM representation 202, multi-dimensional GMM representation 202 may be constructed by merging the constructed multi-dimensional GMM representations (e.g., analogous to multi-dimensional GMM representation 202) of the smaller subsets of rows 204_{1-Q}. It is known to one skilled in the art that construction of GMM distributions 180_{1-P} may involve execution of an Expectation-Maximization (EM) algorithm (e.g., EM algorithm 192 that is part of GMM construction algorithm 190 in FIG. 1) that takes information about parameters (e.g., means, standard deviations, weights, a number of constituent Gaussian distributions) of GMM distributions 180_{1-P} as an input thereto. In one or more embodiments, in the case of merging the multi-dimensional GMM representations, the analogous one-dimensional GMM distributions (e.g., analogous to GMM distributions 180_{1-P}) for the smaller subset of rows 204_{1-Q} for each column 110_{1-P} may first be constructed using EM algorithm 190 and merged into GMM distribution 180_{1-P} for all rows 204_{1-Q} of the each column 110_{1-P}. In one or more embodiments, the smaller subsets of rows 204_{1-Q} for which distinct numeric values are added to data column 206 may be clustered together through a data clustering algorithm 350 (e.g., shown as stored in memory 114₁ in FIG. 3; data clustering algorithm 350 may perform all data clustering operations discussed herein and above and may be part of GMM construction algorithm 190); data clustering algorithm 350 may be executed over the space of correlation coefficients 212 between specific groups of the distinct numeric values and the constituent Gaussian distributions of the merged GMM distribution 180_{1-P}.

In one or more embodiments, the splitting of input data 170 into the smaller subsets of rows 204_{1-Q} may be optimized in accordance with: maximizing the ability of the corresponding one-dimensional GMM distributions to approximate original local distributions of the numeric values across the smaller subsets of rows 204_{1-Q} and to accurately represent local multi-dimensional correlations of the numeric values thereacross. In one or more embodiments, rows 204_{1-Q} in input data 170 may be obtained as outputs of multi-dimensional transformations of complex objects (e.g., complex objects 360) into vectors of the numeric values; complex objects 360 may include but are not limited to images, videos, texts and/or time-series of sensor measurements. In one or more embodiments, one or more of the aforementioned transformations may involve a feature extraction operation, an embedding operation and/or an internal layer of an autoencoder (e.g., a neural network). In one or more embodiments, GMM distributions 180_{1-P} (or analogous GMM distributions) and/or multi-dimensional GMM representation 202 may be stored (e.g., in memory 114₁) together with complex objects 360 and/or smaller subsets of complex objects 360 with or without the outputs of the aforementioned transformations. Alternatively, in one or more embodiments, GMM distributions 180_{1-P} (or analogous GMM distributions) and/or multi-dimensional GMM representation 202 may be stored (e.g., in memory 114₁) together with the outputs of the aforementioned transformations but without complex objects 360 or smaller subsets thereof.

In one or more embodiments, an operation (e.g., ML algorithm 160 learning an ML model, preparing a business intelligence report) executed through data processing device 102₁/computing system 100 may require generation of one or more data sample(s) (e.g., data sample(s) 330). In one or more embodiments, here, artificial rows 332 may be generated based on multi-dimensional GMM representation 202 by: (i) random selection of a combination of constituent Gaussian distributions of one or more specific GMM distributions 180_{1-P} in accordance with a joint probability distribution spanned over the combination, and (ii) generation of specific numeric values of artificial rows 332 based on the one or more specific GMM distributions 180_{1-P} that the combination includes. In one or more embodiments, data sample(s) 330 may be generated by selecting a smaller subset of the smaller subsets of rows 204_{1-Q} discussed above in accordance with finding multi-dimensional GMM representations (e.g., analogous to multi-dimensional GMM representation 202) that are representative of all GMM distributions 180_{1-P} of the smaller subsets of rows 204_{1-Q}, and generating artificial rows (e.g., analogous to artificial rows 332) based on the found multi-dimensional GMM representations and/or selecting the actual rows 204_{1-Q} that belong to the selected smaller subset.

In one or more embodiments, the choice of multi-dimensional GMM representation 202 that is representative of all multi-dimensional GMM representations above may be based on analysis of distances between these multi-dimensional GMM representations, including GMM distributions (e.g., analogous to GMM distributions 180_{1-P}) thereof as well as coefficients of correlation (e.g., analogous to correlation coefficients 212) with data column 206. In one or more embodiments, the distance analysis may be based on a Wasserstein distance and/or a Kullback-Leibler divergence. In one or more embodiments, one of the operations discussed above performed through computing system 100/data processing device 102₁ may involve data clustering, wherein clusters of similar complex objects 360 discussed above may be searched entirely based on the multi-dimensional GMM representations/multi-dimensional GMM representation 202.

In one or more embodiments, another operation may involve finding a subset of complex objects 360 that is most similar to a complex object (e.g., input complex object 362) specified as an input thereto. In one or more embodiments, the process of finding/searching may involve transformation of input complex object 362 into a vector of numeric values and analyzing the vector against multi-dimensional GMM representations of specific smaller subsets of complex objects 360 to find the subset that has a highest probability of including complex objects similar to input complex object 362 therein. Here, in one or more embodiments, the highest probability is calculated based on an expected chance that the vector of numeric values of input complex object 362 may be generated by combinations of constituent Gaussian components of the analogous GMM distributions of the specific smaller subsets of complex objects 360 subject to joint probabilities of the aforementioned combinations being derived from the multi-dimensional GMM representations of the specific smaller subsets of complex objects 360.

In one or more embodiments, one of the operations discussed above may take two data tables as input data 170, where the goal is to find pairs of data columns (e.g., column 110_{1-P} and a column of another set of analogous columns) belonging to different data tables across the two such that multi-dimensional GMM representations thereof may be closest to each other. Here too, in one or more embodiments, the closeness of the multi-dimensional GMM representations including GMM distributions thereof as well as analogous correlation coefficients with data column 206 may be measured based on a Wasserstein distance and/or a Kullback-Leibler divergence. In one or more embodiments, in the case of there being at least two sources of complex objects 360, multi-dimensional GMM representations thereof may be built and compared to one another to verify semantic similarity of complex objects 360 coming from the at least two sources.

As discussed above, in one or more embodiments, the sole storage of multi-dimensional GMM representation 202 and/or GMM distributions 180_{1-P} may reduce a data footprint of input data 170 within computing system 100/data processing device 102₁. In one or more embodiments, the reduction of the data footprint may be accompanied by increased speed of various analytics and/or AI/related computations (e.g. based on ML algorithm 160) in accordance with performance thereof against multi-dimensional GMM representation 202/GMM distributions 180_{1-P} and/or other data discussed above instead of input data 170. In one or more embodiments, intelligence and/or insights pertaining to input data 170 may be made available through these multi-dimensional GMM representations (e.g., multi-dimensional GMM representation 202)/GMM distributions 180_{1-P} and/or the other data instead of input data 170, thereby providing for opportunities to shield and/or exclude input data 170 from unauthorized and/or undesired access. Last but not the least, in one or more embodiments, sole access to the aforementioned intelligence, insights and/or the aforementioned multi-dimensional GMM representations (e.g., multi-dimensional GMM representation 202)/GMM distributions 180_{1-P} and/or the other data may be implemented through various means such as role-based entitlements (e.g., implemented through an entitlements server).

It should be noted that drawing elements of FIGS. 1-3 other than data processing devices 102_{1-N} and computing network 104 may be executable through processor 112₁, results of processing therethrough, inputs thereto and/or stored in memory 114₁, even if FIGS. 1-3 do not show one or more of the aforementioned explicitly. Further, it should be noted that the operations discussed herein may be performed based on execution of ML algorithm 160/GMM construction algorithm 190/EM algorithm 192/data clustering algorithm 350 on processor 112₁. In one or more embodiments, input data 170 itself may be organized in a tabular form including rows 204_{1-Q} and columns 110_{1-P} using processor 112₁ to facilitate the aforementioned operations. All reasonable variations are within the scope of the exemplary embodiments discussed herein.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., computing system 100, data processing device 102₁), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of generating a multi-dimensional Gaussian Mixture Model (GMM) representation of a data set using a processor communicatively coupled to a memory, comprising:
constructing a GMM distribution separately for each column of the data set to form a number of GMM distributions;
enriching the data set by adding a new data column whose numeric values correspond to at least one specific row of the data set, the numeric values of the new data column chosen in accordance with maximizing an average correlation between the new data column and at least one GMM distribution of the number of GMM distributions corresponding to at least one specific column of the data set;
forming the multi-dimensional GMM representation as comprising a discrete probability distribution of the numeric values of the new data column, sets of parameters of all of the number of GMM distributions, and correlation coefficients between the numeric values of the new data column and constituent Gaussian distributions of the number of GMM distributions;
encoding, through the numeric values of the new data column, correlations between the numeric values across the columns of the data set in order to calculate the correlation coefficients directly from the new data column and the number of GMM distributions; and
reducing a data footprint of the data set in accordance with the forming of the multi-dimensional GMM representation.

2. The method of claim 1, further comprising:
expressing the correlation coefficients in the form of conditional probability distributions;
calculating conditional probabilities associated with the conditional probability distributions in accordance with calculating, for each row of the data set and an associated column thereof, a probability that the numeric value corresponding thereto is generated based on each constituent Gaussian distribution of an associated GMM distribution of the number of GMM distributions; and
for each numeric value of the new data column and the each column of the data set, summing up the conditional probability distributions over all rows of the data set that have the numeric value thereof in the new data column and normalizing the summed conditional probability distributions to a number of the rows of the data set that have the numeric value thereof in the new data column.

3. The method of claim 2, further comprising populating the new data column based on at least one of:
minimizing a sum of conditional entropies of the number of GMM distributions of all the columns of the data set subject to the new data column; and
maximizing an accuracy of a Bayesian belief network having a root node corresponding to the new data column and directed edges from the root node to each other node of the Bayesian belief network corresponding to specific columns of the data set, the root node associated with a prior distribution of the numeric values over the new data column and the other nodes associated with the conditional probability distributions of specific constituent Gaussian distributions of the number of GMM distributions subject to specific numeric values in the new data column.

4. The method of claim 2, further comprising populating the new data column by:
mapping every row of the data set into a multi-dimensional space constituted by the multi-dimensional GMM representation;
creating the multi-dimensional space by concatenating the conditional probabilities pertaining to generating the numeric value of the each row of the data set on a specific column thereof using each constituent Gaussian distribution of the GMM distribution of the specific column; and
performing data clustering for the rows in the multi-dimensional representation such that the each numeric value of the new data column is assigned at least one distinct number of data clusters associated therewith formed through the data clustering.

5. The method of claim 2, further comprising populating the new data column in accordance with:
calculating correlation between the GMM distributions of the number of GMM distributions for every pair of the columns of the data set;
selecting the column whose GMM distribution of the number of GMM distributions is, on average, most strongly correlated to all other GMM distributions of the number of GMM distributions; and
deriving the new data column from the selected column based on a discretization process.

6. The method of claim 1, further comprising at least one of:
in accordance with a number of distinct numeric values of the new data column yielding the multi-dimensional GMM representation that is not a significantly better representative of an original joint data distribution across the columns of the data set than with a lower number of distinct numeric values of the new data column, updating the multi-dimensional GMM representation with the construction thereof with the lower number of distinct numeric values of the new data column;
the multi-dimensional GMM representation at least one of: replacing the data set and being available as an approximate model of the data set for an operation to be performed through the processor;
storing the multi-dimensional GMM representation as metadata in the memory in addition to the data set for availability thereof for the operation to be performed trough the processor;
storing the number of GMM distributions as one of: the metadata and another metadata of the columns of the data set in the memory; and
storing the new data column in the memory for the operation to be performed through the processor, with a distribution of the numeric values in the new data column serving as yet another metadata of specific columns of the columns of the data set.

7. The method of claim 1, further comprising:
splitting the data set into smaller subsets of rows thereof;
constructing and storing multi-dimensional GMM representations analogous to the multi-dimensional GMM representation of the data set for each smaller subset of the rows separately; and
in response to a requirement of reference to the multi-dimensional GMM representation of the data set, constructing the multi-dimensional GMM representation of the data set by merging the multi-dimensional GMM representations of the smaller subsets of the rows.

8. The method of claim 7, further comprising at least one of:
constructing, through execution of an Expectation-Maximization (EM) algorithm on the processor, GMM distributions analogous to the number of GMM distributions for the smaller subsets of the rows;
merging the constructed GMM distributions analogous to the number of GMM distributions into the GMM distribution for all rows of the each column of the data set;
clustering together, based on execution of a data clustering algorithm on the processor, the smaller subsets of the rows for which distinct numeric values are added to the new data column;
executing the data clustering algorithm over a space of the correlation coefficients between specific groups of the distinct numeric values and the constituent Gaussian distributions of the merged GMM distribution; and
optimizing the splitting of the data set into the smaller subsets of the rows in accordance with maximizing an ability of the corresponding constructed GMM distributions to at least one of:
approximate original local distributions of the numeric values across the smaller subsets of the rows, and
accurately represent local multi-dimensional correlations of the numeric values across the smaller subsets of the rows.

9. The method of claim 1, further comprising at least one of:
obtaining rows of the data set as an output of a multi-dimensional transformation of at least one complex object into vectors of the numeric values;
the at least one complex object being at least one of: an image, a video, a text and a time-series of sensor measurements;
the multi-dimensional transformation involving at least one of: a feature extraction operation, an embedding operation and an internal layer of an autoencoder; and
storing at least one of: the number of GMM distributions and the multi-dimensional GMM representation together with at least one of: the at least one complex object, at least one smaller subset of the at least one complex object, and the output of the multi-dimensional transformation.

10. The method of claim 8, further comprising:
generating at least one data sample for an operation to be executed through the processor;
the operation being related to at least one of: learning a Machine Learning (ML) model, preparing a business intelligence report, and data clustering; and
generating artificial rows based on the multi-dimensional GMM representation by:
randomly selecting a combination of the constituent Gaussian distributions of at least one specific GMM distribution of the number of GMM distributions in accordance with a joint probability distribution spanned over the combination, and
generating specific numeric values of the artificial rows based on the at least one specific GMM distribution that the combination includes.

11. The method of claim 10, further comprising generating the at least one data sample by:
selecting a smaller subset of the smaller subsets of the rows in accordance with finding multi-dimensional GMM representations that are representative of all the GMM distributions of the smaller subsets of the rows; and
at least one of:
generating the artificial rows based on the found multi-dimensional GMM representations; and
selecting the actual rows that belong to the selected smaller subset.

12. The method of claim 8, further comprising:
choosing the multi-dimensional GMM representation as representative of all the multi-dimensional GMM representations analogous thereto based on analysis of distances between the analogous multi-dimensional GMM representations as well as analogous coefficients of correlation with the new data column; and
the analysis of the distances being based on at least one of: a Wasserstein distance and a Kullback-Leibler divergence.

13. The method of claim 8, further comprising finding a subset of at least one complex object that is most similar to an input complex object in accordance with:
transforming the input complex object into a vector of numeric values and analyzing the vector against the multi-dimensional GMM representations of specific smaller subsets of the at least one complex object to find the subset that has a highest probability of including complex objects similar to the input complex object; and
calculating the highest probability based on an expected chance that the vector is generated by combinations of constituent Gaussian components of the analogous GMM distributions of the specific smaller subsets of the at least one complex object subject to joint probabilities of the combinations being derived from the multi-dimensional GMM representations thereof.

14. The method of claim 8, further comprising:
the data set comprising two data tables;
finding pairs of columns belonging to the two data tables such that the multi-dimensional GMM representations thereof are closest to one another; and
measuring closeness of the multi-dimensional GMM representations of the two data tables based on at least one of: a Wasserstein distance and a Kullback-Leibler divergence.

15. A data processing device to generate a multi-dimensional GMM representation of a data set, comprising:
a memory; and
a processor communicatively coupled to the memory, the processor executing instructions stored in the memory to:
construct a GMM distribution separately for each column of the data set to form a number of GMM distributions,
enrich the data set by adding a new data column whose numeric values correspond to at least one specific row of the data set, the numeric values of the new data column chosen in accordance with maximizing an average correlation between the new data column and at least one GMM distribution of the number of GMM distributions corresponding to at least one specific column of the data set,
form the multi-dimensional GMM representation as comprising a discrete probability distribution of the numeric values of the new data column, sets of parameters of all of the number of GMM distributions, and correlation coefficients between the numeric values of the new data column and constituent Gaussian distributions of the number of GMM distributions,
encode, through the numeric values of the new data column, correlations between the numeric values across the columns of the data set in order to calculate the correlation coefficients directly from the new data column and the number of GMM distributions, and
reduce a data footprint of the data set in accordance with the forming of the multi-dimensional GMM representation.

16. The data processing device of claim 15, wherein the processor further executes instructions to:
express the correlation coefficients in the form of conditional probability distributions,
calculate conditional probabilities associated with the conditional probability distributions in accordance with calculating, for each row of the data set and an associated column thereof, a probability that the numeric value corresponding thereto is generated based on each constituent Gaussian distribution of an associated GMM distribution of the number of GMM distributions, and
for each numeric value of the new data column and the each column of the data set, sum up the conditional probability distributions over all rows of the data set that have the numeric value thereof in the new data column and normalize the summed conditional probability distributions to a number of the rows of the data set that have the numeric value thereof in the new data column.

17. The data processing device of claim 16, wherein the processor further executes instructions to populate the new data column by:
mapping every row of the data set into a multi-dimensional space constituted by the multi-dimensional GMM representation,
creating the multi-dimensional space by concatenating the conditional probabilities pertaining to generating the numeric value of the each row of the data set on a specific column thereof using each constituent Gaussian distribution of the GMM distribution of the specific column, and
performing data clustering for the rows in the multi-dimensional representation such that the each numeric value of the new data column is assigned at least one distinct number of data clusters associated therewith formed through the data clustering.

18. A data processing device to generate a multi-dimensional GMM representation of a data set, comprising:
a memory; and
a processor communicatively coupled to the memory, the processor executing instructions stored in the memory to:
construct a GMM distribution separately for each column of the data set to form a number of GMM distributions,
enrich the data set by adding a new data column whose numeric values correspond to at least one specific row of the data set, the numeric values of the new data column chosen in accordance with maximizing an average correlation between the new data column and at least one GMM distribution of the number of GMM distributions corresponding to at least one specific column of the data set,
form the multi-dimensional GMM representation as comprising a discrete probability distribution of the numeric values of the new data column, sets of parameters of all of the number of GMM distributions, and correlation coefficients between the numeric values of the new data column and constituent Gaussian distributions of the number of GMM distributions,
encode, through the numeric values of the new data column, correlations between the numeric values across the columns of the data set in order to calculate the correlation coefficients directly from the new data column and the number of GMM distributions, and
utilize the multi-dimensional GMM representation one of: along with and instead of the data set for computation using a Machine Learning (ML) algorithm also executing on the processor.

19. The data processing device of claim 18, wherein the processor further executes instructions to:
express the correlation coefficients in the form of conditional probability distributions, calculate conditional probabilities associated with the conditional probability distributions in accordance with calculating, for each row of the data set and an associated column thereof, a probability that the numeric value corresponding thereto is generated based on each constituent Gaussian distribution of an associated GMM distribution of the number of GMM distributions, and
for each numeric value of the new data column and the each column of the data set, sum up the conditional probability distributions over all rows of the data set that have the numeric value thereof in the new data column and normalize the summed conditional probability distributions to a number of the rows of the data set that have the numeric value thereof in the new data column.

20. The data processing device of claim 19, wherein the processor further executes instructions to populate the new data column by:
mapping every row of the data set into a multi-dimensional space constituted by the multi-dimensional GMM representation,
creating the multi-dimensional space by concatenating the conditional probabilities pertaining to generating the numeric value of the each row of the data set on a specific column thereof using each constituent Gaussian distribution of the GMM distribution of the specific column, and
performing data clustering for the rows in the multi-dimensional representation such that the each numeric value of the new data column is assigned at least one distinct number of data clusters associated therewith formed through the data clustering.
